(19) United States
(12) Patent Application Publication
(10) Pub. No.: US 2002/0124158 A1
(43) Pub. Date: Sep. 5, 2002

(54) Virtual r0 register

(76) Inventor: Nicholas G. Samra, Austin, TX (US)

Correspondence Address: KENYON & KENYON, 333 W. San Carlos, Street, Suite 600, San Jose, CA, 95110-2711, US

(21) Appl. No.: 09/752,243

(22) Filed: Dec. 28, 2000

(51) Int. Cl. G06F 9/00

(52) U.S. Cl. 712/226

(57) ABSTRACT

An apparatus and method for efficiently generating a zero value may be used with instruction set architectures which do not support an explicit zero reading register (r0) to speed execution. The present invention includes a physical register that reads out a value of zero when accessed, and a Zero Instruction Logic (ZIL) unit that identifies instructions that appear to be compensating for the lack of an r0 register, and modify the stream of instructions to utilize the physical register. Embodiments of the present invention may decrease the number of instructions that must be executed, and may decrease false dependencies between instructions allowing more scheduling flexibility.

### FIELD OF THE INVENTION

The present invention relates to computer architecture. More particularly, the present invention relates to generating a zero value with instruction sets that do not use an explicit zero register.

### BACKGROUND OF THE INVENTION

There is often the need within a computer algorithm to produce a value of zero. Resetting a counter by storing a zero is but one of many such examples.

Some instruction set architectures have an “r0” register which returns a zero value when it is read. The r0 register is typically a read only memory (ROM), which is ideally suited for producing a zero, it always reads out the value zero. Other instruction set architectures, for a variety of reasons, do not include r0 registers for directly producing a zero value, and require the use of indirect zero-generating instructions. The disadvantage of using indirect instructions, is that they typically require an extra instruction, compared to using an r0 register, which makes them less computationally efficient. It would be desirable to eliminate or reduce these inefficiencies.

One solution to the inefficiency of zero-generating without an r0 register might be to require that all architectures include an r0 register. This solution, however, would not necessarily improve the performance of millions of lines of existing, or legacy, software written for architectures without an r0 register. In addition, current instruction set architectures, such as, but not limited to, the IA-32 Intel® architecture do not support a zero-generating r0 register. It would be desirable to provide efficient zero-generation for such instruction set architectures.

The pace of development for both microprocessors and software over the past two decades has been brisk. Design decisions made 15 or 20 years ago, based what was then available, might well be decided differently today if not for the existence of legacy systems. One such design decision was to omit the r0 register in some instruction set architectures, most likely to maximize the number of general purpose registers. Modern instruction set architectures, generally with a greater total number of registers, can more easily justify dedicating a register to zero-generating.

The present invention uses the parallelism of modern microprocessors to find zeroing instructions, substitute a virtual R0 register, and to speed the execution time for the program. In doing so, the present invention brings the advantages of an r0 register to an instruction set architecture which does not include a zero-generating r0 register.

### BRIEF DESCRIPTION OF THE DRAWINGS

FIG. 1 is an example of a register alias table (RAT) and a physical register file in accordance with an embodiment of the present invention.

FIGS. 2A and 2B are sample trace cache lines in accordance with the prior art and in accordance with an embodiment of the present invention, respectively.

### DETAILED DESCRIPTION

The present invention is directed to providing an efficient method of zero-generating for microprocessor instruction set architectures that lack a dedicated zero-generating r0 register.

Without a zero-generating r0 register, compilers and assembly language programmers must use other means of creating a value of zero. Those of ordinary skill in the art will recognize the following examples are but a few of the many techniques for zeroing register r5:

XOR r5, r5, r5

SUB r5, r5, r5

MUL r5, r5, 0x0

MOV r5, 0x00000000

One disadvantage of using the above zero-generating instructions is that an extra step is required compared to simply reading zero from an r0 register. These instructions serve to store a value of zero in register r5 so that, at least temporarily, a zero may be read. That is, the one line instruction creates what would inherently exist in an r0 register.

An additional problem is the false dependency created by the XOR, SUB and MUL instructions, which may interfere with scheduling, or re-ordering, of these instructions. Since each of the instructions uses register r5 as a source, although the particular value in r5 is irrelevant, most rename units would only allow execution of the instruction after the last instruction to write to register r5. This false dependency on the prior value of register r5 causes an unnecessary constraint in scheduling and may unnecessarily delay the execution of the instruction.

The MOV instruction does avoid the false dependency problem, but is often not used because a MOV may require more bytes to encode than some other zero-generating instructions. Compilers may use a XOR, for example, because the performance degradation of a false dependency is less significant than encoding more bytes.

The present invention uses a dedicated zero-value register, PR0, which is preferably a read only memory (ROM), in a physical register file. The PR0 is linked to the virtual R0 register, producing a value zero when read. The PR0 entry, unlike register r5 above, is never written.

In order to be compatible with existing code, in an embodiment of the present invention, the instruction set does not have any explicit access to PR0. Rather, PR0 is accessed through a virtual R0 register that may be utilized when zero-generating instructions, such as:

XOR r5, r5, r5

SUB r5, r5, r5

MUL r5, r5, 0x0

MOV r5, 0x00000000

are used. Those of ordinary skill in the art will recognize that the above list is not exhaustive, and the present invention is not intended to be limited to use with any particular zero-generating instructions.

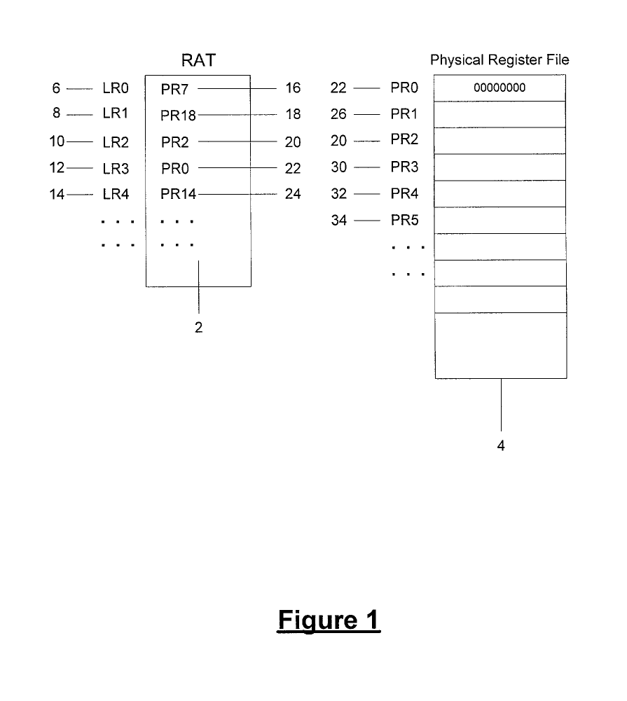

An embodiment of the present invention uses pointers to the PR0 within a register alias table (RAT), mapping between logical registers (e.g., LR3) and physical registers (e.g., PR3). The RAT is in turn linked to the renaming unit of the microprocessor. FIG. 1 depicts logical registers in a RAT 2 and a corresponding physical register file 4. Logical registers LR0, LR1, LR2, LR3, and LR4 (6, 8, 10, 12, and 14) are associated with physical registers PR7, PR18, PR2, PR0, and PR14 (16, 18, 20, 22, and 24) respectively. In FIG. 1, only logical register LR3 12 currently contains a zero entry and references PR0 22. PR0 22 in physical register file 4 is preferably a zero-generating ROM, and may have pointers to it from multiple logical registers, although, only one is present in this example. Physical registers PR1 through PR5 (26, 20, 30, 32, and 34) may be used for storing any data value, including zero, that is creating by any means other than a zero-generating instruction. PR1 through PR5 are preferably random access memory (RAM) locations. In most cases RAT 2 entries may be altered by the renaming unit of the microprocessor while properly maintaining the pointers to PR0 22.

In addition to the physical register PR0 22, embodiments of the present invention use zeroing instruction logic (ZIL) to build a sequence of instructions for execution. The ZIL works in conjunction with the logic that builds instructions into a trace cache. The instructions are ordered in an execution sequence and the ZIL searches for zeroing instructions and modifies the instructions in the trace cache.

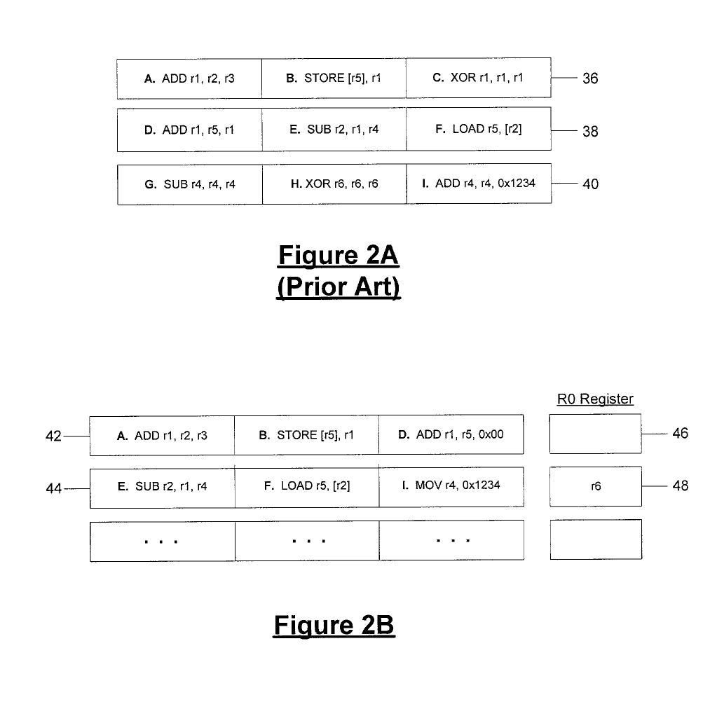

Turning now to FIG. 2, which illustrates the ZIL and the make-up of a three instruction trace cache line, using both prior art scheduling in FIG. 2A and an embodiment of the present invention in FIG. 2B, with the following instructions:

| | | |
|---|---|---|
| A. | ADD | r1, r2, r3 |
| B. | STORE | [r5], r1 |
| C. | XOR | r1, r1, r1 |
| D. | ADD | r1, r5, r1 |
| E. | SUB | r2, r1, r4 |
| F. | LOAD | r5, [r2] |
| G. | SUB | r4, r4, r4 |
| H. | XOR | r6, r6, r6 |
| I. | ADD | r4, r4, 0x1234 |

Note that instructions C, G and H are zeroing instructions for storing a zero in registers r1, r4 and r6 respectively. Also note that the three trace cache lines 36, 38 and 40 required by prior art have been reduced to two trace cache lines 42 and 44, by the ZIL unit, with fewer instructions to execute. The ZIL eliminates zeroing instruction C and modifies instruction D by using an immediate source of 0x00 instead of a zeroed register r1. The resulting value in register, after the execution of instruction D, is the same but is now accomplished with one less instruction. Because instruction D immediately overwrites register r1, there is no need to make any entry into the first trace cache line r0 register field 46. Instructions E and F are not zeroing instructions, nor do they use a zeroed register, and are not changed by an embodiment of the present invention.

Instructions G and H are zeroing instructions, setting the value of registers r4 and r6 to zero, so they are candidates for elimination by the ZIL. However, ZIL also looks ahead to the effect of these zeroing instructions. Instruction G zeros register r4 so that instruction I can later place the constant 0x1234 into r4 with an ADD instruction. Because of instruction I, there is again no need to preserve a zeroed register r4 beyond the end of trace cache line 44. Unlike combined instructions G and I, the zeroing of register r6 by instruction H is not immediately overwritten, so this zero is preserved by an entry for register r6 in the second cache line r0 register field 48. More precisely, the above corresponds to an entry for logical register, LR6, in the RAT, which will provide a pointer to the physical register PR0. The entry in the RAT allows the register mapping to be preserved when the rename unit renames trace cache line 48. Those of ordinary skill in the art are familiar with such renaming procedures, and the present invention is not intended to be limited to use with any particular renaming system.

Instruction G is related to instruction I in that the zero-generation by instruction G cleared register r4 for the constant 0x1234. An embodiment of the present invention recognizes pairs of instructions such as G and I with the ZIL, and then converts the ADD statement of the original instruction I to a two argument MOV statement.

As shown above, embodiments of the present invention eliminate the false dependencies that may be created by zero-generating instruction, and may completely eliminate many of the zero-generating instructions. Generally, eliminating these instructions from the trace cache line leads to faster execution and lower power consumption. Similarly, a smaller number of instructions in the trace cache, while providing the same functionality as a larger number of instructions, tends to lead to a high trace cache hit rate, a higher trace cache read bandwidth, and perhaps a higher rename bandwidth. Even with a constant number of instructions, the elimination of false dependencies between instructions may eliminate some of the artificial constraints on instruction scheduling, leading to faster throughput.

The present invention may be implemented in hardware, software, firmware, as well as in programmable gate array devices, ASICs and other similar devices.

While embodiments and applications of this invention have been shown and described, it would be apparent to those skilled in the art, after a review of this disclosure, that many more modifications than mentioned above are possible without departing from the inventive concepts herein. The invention, therefore, is not to be restricted except in the spirit of the appended claims.

What is claimed is:

1. A zero-generating apparatus for use with an instruction set architecture without an r0 register, comprising:
a physical zero register which reads as a zero value;
a Register Alias Table (RAT) for storing an instruction register map; and
a Zeroing Instruction Logic (ZIL) unit for detecting a zeroing instruction and modifying said RAT with a pointer to said physical zero register.

2. An apparatus in accordance with claim 1, wherein:
said physical zero register is a read only memory (ROM).

3. An apparatus in accordance with claim 1, wherein:
said ZIL unit detects said zeroing instruction in a trace cache line.

4. An apparatus in accordance with claim 3, further comprising:
an r0 register field logically coupled to said trace cache line for mapping to said physical zero register.

5. An apparatus in accordance with claim 3, wherein:
said RAT and said trace cache line are logically coupled to a renaming unit for maintaining said pointer to said physical register.

6. An apparatus in accordance with claim 3, wherein:
said ZIL unit deletes said zeroing instruction from said trace cache line.

7. An apparatus in accordance with claim 6, wherein:
said ZIL unit modifies a subsequent instruction, where said subsequent instruction is logically coupled to said zeroing instruction within said trace cache line.

8. An apparatus in accordance with claim 7, wherein:
said ZIL unit modifies said subsequent instruction with an immediate source of zero.

9. An apparatus in accordance with claim 1, wherein:
said zeroing instruction is an exclusive or (XOR).

10. An apparatus in accordance with claim 1, wherein:
said zeroing instruction is a subtraction (SUB).

11. An apparatus in accordance with claim 1, wherein:
said zeroing instruction is a multiply (MUL).

12. An apparatus in accordance with claim 1, wherein:
said zeroing instruction is a move (MOV).

13. An apparatus in accordance with claim 7, wherein:
said ZIL unit transforms said subsequent instruction to a MOV instruction.

14. A zero-generating apparatus for use with a microprocessor, comprising:
a physical zero register which reads as a zero value;
a Zeroing Instruction Logic (ZIL) unit for reading a plurality of instructions and detecting and modifying a zeroing instruction within said plurality of instructions;
where said ZIL unit deletes said zeroing instruction and sets a pointer to said physical zero register in place of said deleted zeroing instruction; and
where said ZIL unit modifies instructions dependent on said deleted zeroing instruction.

15. An apparatus in accordance with claim 14, wherein:
said ZIL unit modifies instructions dependent on said deleted zeroing instructions with an immediate source of a value when both occur with a single trace cache line.

16. An apparatus in accordance with claim 14, wherein:
said ZIL unit modifies instructions dependent on said deleted zeroing instructions with a renameable pointer.

17. A method of zero-generating with an instruction set architecture with an r0 register, comprising:
detecting a zeroing instruction;
deleting said zeroing instruction;
identifying a subsequent instruction using said zeroing instruction; and
modifying said subsequent instruction.

18. A method in accordance with claim 17, further comprising:
pointing to a physical zero register where said subsequent instruction is not within a common trace cache line.

19. A method in accordance with claim 17, wherein:
modifying said subsequent instruction involves replacing instruction sources.

20. A method in accordance with claim 17, wherein:
modifying said subsequent instruction involves using a move (MOV) instruction.

21. A method in accordance with claim 17, wherein:
said subsequent instruction is modified in response to its location in a trace cache relative to said zeroing instruction.
